(19) United States
(12) Patent Application Publication
(10) Pub. No.: US 2026/0194358 A1
(43) Pub. Date: Jul. 9, 2026

(54) Systems and Methods for Traffic Control During an Evacuation

(71) Applicant: STC, Inc., McLeansboro, IL (US)

(72) Inventors: Brad Cross, McLeansboro, IL (US); Terry Fryar, Benton, IL (US)

(21) Appl. No.: 19/401,778

(22) Filed: Nov. 26, 2025

Related U.S. Application Data
(60) Provisional application No. 63/725,003, filed on Nov. 26, 2024.

(51) Int. Cl. G01C 21/34; G08G 1/07; G08G 1/087

(52) U.S. Cl. CPC G01C 21/3461; G08G 1/07; G08G 1/087

(57) ABSTRACT

Traffic controls systems, and methods of their operation, that are designed to provide for unique traffic control in the event of an evacuation by utilizing existing signal lights and a priority system which grants vehicles priority based on the needs of an evacuation traffic flow, as opposed to traditional traffic flows. These systems will typically be arranged to maximize traffic flow into and along a known evacuation route while still recognizing that vehicular traffic along other routes, and even opposing routes, particularly for emergency vehicles, is necessary.

### CROSS REFERENCE TO RELATED APPLICATION(S)

This application claims the benefit of U.S. Provisional Patent Application Ser. No. 63/725,003, filed Nov. 26, 2024, the entire disclosure of which is herein incorporated by reference.

### BACKGROUND OF THE INVENTION

### Field of the Invention

This disclosure is related to the field of traffic control and traffic flow, particularly to systems and methods for the management of traffic flow through the controlling of signal lights during an emergency evacuation.

### Description of the Related Art

In the perfect urban commuter's utopia, signal lights would automatically switch to green every time a driver or pedestrian approached an intersection, creating an unobstructed pathway towards the individual's final destination regardless of the type of vehicle- or lack of vehicle. However, in real life, encountering a red light at an intersection or a “DON'T WALK” signal at a crosswalk is a normal and inevitable part of urban travel.

There are many substantial benefits to be reaped from improved traffic flow through a traffic grid for all types of vehicles and under a variety of circumstances. During an emergency evacuation it is even more important to have improved traffic flow through a traffic grid. For many commuters evacuating via existing evacuation systems and methods, being stuck in evacuation traffic is a fact of life. But having a system that improves such evacuation to alleviate traffic jams and backups may result in a more streamlined evacuation of all evacuees. Also, a system that streamlines evacuation will further reduce congestion on the roads, and less congestion on the roads may generate fewer accidents, thereby saving lives.

Further, congested traffic and uncoordinated signal lights can cause delays in the evacuation that, if not remedied, can impede many persons' ability to reach safety. Moreover, increased wait times and traffic may cause automobile drivers to become rushed and speed to arrive at their destination as quickly as possible, which can result in drivers losing focus on the road and having more accidents. Likewise, the increased wait times and traffic may also cause pedestrians, bicyclists, or other non-automobile travelers to take unnecessary risks when travelling in order to reduce wait and or travel times. This is especially true during an emergency evacuation, which may in itself be a life and death situation, and adding the increased stress of waiting at a seemingly never-changing traffic light may cause evacuees to act recklessly in attempt to get to safety.

In addition to the general sense of life or death that comes with an emergency evacuation, there are also situations during the evacuation where improved traffic flow can be the literal difference between life and death. These situations are mainly when an emergency vehicle cannot get through the traffic to reach their intended destination, which may result in patients dying. Existing traffic priority systems account for these emergency vehicles by using a type of priority system.

The most well known of these is unquestionably where a “priority” vehicle, typically an emergency vehicle such as an ambulance or fire engine, can be given a clear path to get from its starting point to where it is needed. Originally, the use of an emergency vehicle's “lights and siren” was used to warn other travelers of its approach and traffic laws universally required other motorists to clear a path regardless of the operation of traffic signaling infrastructure. However, as the amount of vehicle traffic increases, which will inevitably be the case during an evacuation up until all persons needing evacuation are evacuated, situations can exist where there is simply no where for other vehicles to go to get out of the path of an emergency vehicle. In these situations, it can be necessary for an emergency vehicle to detour around the problem area, completely slowing the emergency vehicle down.

Various attempts have been made over the years to utilize existing traffic infrastructure to clear the path ahead for an emergency vehicle or otherwise assign priority to particular vehicles. Such systems are disclosed in, for example, U.S. Pat. Nos. 8,878,695; 9,953,522; 11,202,302; 11,250,700; and U.S. patent application Ser. No. 18/233,151, the disclosures of which are hereby incorporated by reference in their entirety. These systems have basically realized that passage of an emergency vehicle or a vehicle with priority is easiest when no one gets into the path in the first place. Thus, systems exist which utilize existing signals to keep vehicles on cross streets as an emergency or priority vehicle approaches, which provides the vehicle a string of green lights to go through. As these systems have become relatively ubiquitous, they have been expanded to give priority to any vehicle which may be desired to have a more unimpeded trip. For example, systems exist to allow for mass transit vehicles to have priority to stay on schedule, or for vehicles with increased occupancy to have increased priority, or to allow for traffic to be regulated in a way that attempts to avoid gridlock by altering traffic flow behind the scenes. But these existing systems are generally configured to assign priority to certain vehicles, i.e., emergency vehicles or mass transit vehicles, and are not well suited for use during an emergency evacuation.

In the attempt to improve traffic flow during an evacuation, there have been a wide variety of different systems developed and implemented. In some cases, these systems are based on road design. For example, some communities utilize switching lanes where all lanes of traffic are directed towards the path of evacuation. Similarly, some communities have expanded the shoulders of major thoroughfares to permit evacuees to utilize the shoulders as extra evacuation lanes. A problem with these systems, however, is that they are generally designed for large thoroughfare type systems and do not work for local roads, which are common for evacuees to travel on during an evacuation.

Within road systems (or traffic grids) such as city grids, there are currently a variety of different control and coordination systems utilized to ensure the smooth and safe management of traffic flows. The primary issue on local roads, as opposed to large interstates, is the regulation of intersecting traffic lanes and the near ubiquitous stoplight, also known as a signal light. While traffic flow through intersections can be improved through the use of roundabouts (or rotaries), these systems are often poorly understood by local drivers (particularly in the United States) and can actually create more problems than they solve. The intersection, instead, creates a near essential requirement to impede the flow of some traffic to facilitate the flow of other traffic. In effect, the interaction of traffic at an intersection requires an assignment of who gets to go through the intersection first. In a default, it is simply whoever has the green light at their time of arrival. However, this process is often inefficient. People will run or accelerate through changing traffic lights to avoid delays and will sometimes even disregard the traffic light if they become upset at being stopped in what they consider an “unfair” situation. These issues become even bigger problems during an evacuation when everyone on the road is attempting to reach an area of safety.

One way to deal with the problems created by traffic lights during an evacuation, is to use the traffic controller system to change the timing of the traffic lights. In a typical traffic controller system, the timing of a particular signal light is controlled by a traffic controller located inside a cabinet that is at a close proximity to the signal light. Generally, the traffic controller cabinet contains a power panel (to distribute electrical power in the cabinet); a detector interface panel (to connect to loop detectors and other detectors for sensing vehicles); detector amplifiers; a controller; a conflict motor unit; flash transfer relays; and a police panel (to allow the police to disable and control the signal), amongst other components.

Traffic controller cabinets generally operate on the concept of phases or directions of movement grouped together to provide for efficient movement through a traffic light. For example, a simple four-way intersection will have two phases: North/South and East/West; a four-way intersection with independent control for each direction and each left hand turn will have eight phases. Controllers also generally operate on the concept of rings or different arrays of independent timing sequences. For example, in a dual ring controller, opposing left-turn arrows may turn red independently, depending on the amount of traffic. Thus, a typical controller is an eight-phase, dual ring controller.

The purpose of the traffic controller cabinet is to ensure that traffic is not waiting at the intersection for a long period of time when there is no opposing traffic in the other direction, and to make sure that traffic can move through the intersection in an orderly fashion. But these systems do not work well for evacuations because most people on the road will be heading in the same direction, to the evacuation route or on the evacuation route, which in many cases will result in no opposing traffic in the other direction but still long wait times at the intersections. This can cause major backups and “gridlock” during the evacuation and lead to drivers, impatiently, running red lights and disobeying normal traffic rules.

Other existing traffic control systems have similar problems for use during an evacuation. For instance, currently utilized control and coordination systems for the typical signal light range from simple clocked timing mechanisms to sophisticated computerized control and coordination systems that self-adjust to minimize the delay to individuals utilizing the roadways. In all cases, the goal is essentially the same: move as many vehicles through the intersection in as little time as possible. This goal does not always align with the objective of an evacuation, which is to direct evacuees to the evacuation route and get as many people to safety as possible.

The simplest control system currently utilized is a timer system. In such a system, each phase of a traffic light lasts for a specific duration until the next phase change occurs. Generally, this specific timed pattern will repeat itself regardless of the current traffic flows or the location of a priority vehicle within the traffic grid. While this type of control mechanism can be effective in one-way grids where it is often possible to coordinate signal lights to a desired travel speed, this control mechanism is generally not advantageous when the signal timing of the intersection would benefit from being adapted to the changing flows of traffic throughout the day. As a result, a timer system is generally no longer used in new traffic signal installations. Timing control mechanisms can also work for lights in sequence (e.g., successive blocks) but generally only work in one direction. Thus, even timing control will generally benefit from at least rudimentary modifications for traffic conditions at different times of day. This control system is likely the most problematic during an evacuation due to the lights strictly cycling on the timer.

Other available traffic control systems, like the timing control systems, are also not sufficient in an evacuation because the lights do not change based on the direction of travel or the number of persons traveling and do not account for the desire to evacuate all persons in the area to an evacuation route. For instance, dynamic signals, also known as actuated signals, are programmed to adjust their timing and phasing to meet the changing ebb and flow in traffic patterns throughout the day. Generally, dynamic traffic control systems use input from vehicle detectors to adjust signal timing and phasing. Detectors are devices that use sensors to inform the controller processor whether vehicles or other road users are present and waiting at the intersection. The signal control mechanism at a given light can utilize the input it receives from the detectors to adjust the length and timing of the phases, or if the phases even occur, in accordance with the current traffic volumes and flows.

For example, should a car be waiting to go straight through an intersection, but no car be waiting to make a left turn from the same direction, the light may turn green for straight traffic, and back to red, without ever triggering a left turn arrow, as none is needed. However, had a vehicle been detected in a turn lane as well, the light may have simultaneously turned green for straight and turning traffic, and the directly opposing direction may never have turned green as no one was waiting. Currently utilized detectors can generally be placed into three main classes: in-pavement detectors, non-intrusive detectors, and demand buttons for pedestrians.

In-pavement detectors are detectors that are located in or underneath the roadway. These detectors typically function similarly to metal detectors or weight detectors, utilizing the metal content or the weight of a vehicle as a trigger to detect the presence of traffic waiting at the light and, thus, can reduce the time period that a green signal is given to an empty road and increase the time period that a green signal is given to a busy throughway during rush hour. Non-intrusive detectors include video image processors, sensors that use electromagnetic waves, or acoustic sensors, each of which may detect the presence of vehicles at the intersection waiting for the right of way from a location generally over the roadway. These non-intrusive detectors generally perform the same function as in-pavement detectors, but do not need to be installed in the pavement. Some models of these non-intrusive detectors have the benefit of being able to sense the presence of vehicles or traffic in a general area or virtual detection zone preceding the intersection as opposed to just those waiting. Vehicle detection in these zones can have an impact on the timing of the phases, as they can often detect vehicles before the vehicles interact with the intersection based on their approach.

Some problems with the above systems, however, as mentioned briefly above, are that the systems are configured to detect motorized vehicles in standard motor vehicle lanes and operating under normal and expected traffic circumstances, not during emergency evacuation conditions. While changes to traffic flow commonly occur at different times of day (e.g. people flowing out of a residential area in the morning and into the same area in an evening), these types of systems are typically configured to handle traffic coming into an intersection from all directions, and leaving in all directions, at all times. While the volume in each direction may change, the system generally still deals with each individual light change on its own, without considering whether there is an evacuation ongoing.

During an emergency evacuation scenario, it is desired to have vehicles treated more equally in getting through an intersection, while simultaneously accelerating as many vehicles as possible through the intersection. Evacuation of an area such as a town or portion of a large city can occur for a variety of reasons, some may require more urgency than others and some may be more dangerous or threatening than others. Most commonly emergency evacuation occurs due to the approach of a known threat such as a natural disaster. While some natural disasters happen suddenly and with little direct warning, for example in the case of a tornado where an increased risk of the disaster is known over a fairly large area but the specific location and timing of the disaster hitting (if at all) is unknown, in certain other forms of natural disaster—like an impending hurricane, for example—the threat is known and can likely damage a wide area. These latter types of concerns are those that often lead to a large evacuation.

Some good examples where large scale evacuations in response to a disaster to avoid loss of life involve hurricanes, water activity (tsunamis and floods), and wildfires. In these types of disasters, there is typically a wide ranging area subject to high levels of danger, but the danger usually takes some time to arrive, which allows time for preparation. Thus, evacuations can allow for human and other life, as well as particularly valuable property, to be removed from the path of the disaster with a fairly high degree of accuracy. Evacuations, however, while effective, are not easily accomplished.

Effective evacuations typically require three distinct steps. The first is that those who live in the area carry out actions when everything is safe to prepare for a future evacuation. This can include knowing where items are that would need to be evacuated, having an understanding of how they are supposed to evacuate (and how they would be told to do so), and even knowing that they are in an area that may need to be evacuated in certain circumstances. Originally, these steps were all performed by individuals in conjunction with public health and safety officials and involved general programs of knowledge. Nowadays, there are also electronic systems available as well that people can sign up to keep them aware of the occurrence of an evacuation in their area. Systems such as ZoneHaven provide alerts to a user's phone that an evacuation is imminent or occurring.

The second distinct step of an evacuation is that individuals be aware that an evacuation may be forthcoming. In these cases, the individuals are usually aware because they are provided with local warnings of a potential cataclysm that could impact them. This is often through local media outlets, but also can be through apps and other notification systems connected to phones such as the above. At this stage, individuals are hopefully ready to evacuate quickly. Vehicles may be prepacked, items placed nearby, and other similar preparations. Further, at this stage some individuals may voluntarily evacuate. Those who have a convenient alternative residence, for example, may leave voluntarily, as may those who are particularly concerned about their ability to evacuate quickly if needed.

The final stage of an evacuation is the evacuation itself. At this stage, an evacuation order is issued and residents in the evacuated area are legally compelled to depart and go elsewhere. It is at this stage where the need for infrastructure to handle the unique transportation issues around an evacuation occur.

Depending on the location of the evacuation and the number of people being evacuated, roads and other infrastructure are often not built to handle the massive amount of traffic heading in effectively the same direction. For areas which are bounded by water, bridges may not be big enough to handle the amount of traffic funneling onto them. Similarly, in areas with limited major roads (e.g. highways), local roads may be insufficient to route traffic efficiently. This is concerning as any traffic entanglement, or an accident, can actually serve to hinder the evacuation as a whole. The lack of sufficient infrastructure, and the control methodology to direct individuals on that infrastructure, can result in an evacuation being ineffective at the point where efficiency is most needed.

It is important to recognize that in an evacuation, most individuals are in a motor vehicle. This is common because it allows for families and other groups to readily travel together, to travel long distances without exhaustion, and for the carrying of important articles without being heavily burdened. Thus, most traffic in an evacuation is carried out by individual family vehicles. While mass transit vehicles may also be put to use in an evacuation (for instance, to carry those who do not own personal vehicles) this is typically uncommon. Further, in an evacuation, vehicle traffic will generally move in a pattern which is completely atypical of normal vehicle movement.

It has been recognized that the high volume of atypical vehicular traffic which occurs in an evacuation can create a wide variety of problems. One major problem is creating gridlock conditions. Gridlock is a form of traffic congestions that is effectively a large traffic jam where continuous lines of vehicles block intersections, impeding the ability of traffic to flow through the intersection, and effectively leaving traffic in all directions at a standstill. Gridlock conditions can exist when there is a heavy flow of traffic going in one direction. This is commonly seen, for example, during a morning or evening commute, where many people are traveling in the same direction to and from work.

While gridlock is not unique to evacuations, it can present significant problems during an evacuation if the infrastructure is not designed to account for and mitigate it. For example, if one traffic light on the evacuation route is out of sequence, it can create a back-up of traffic that results in a gridlock condition, which can impede movement of all traffic towards the evacuation route. Alternatively, if a gridlock condition is created and the traffic infrastructure is not designed to account and adjust for it, the people attempting to evacuate may be struck in traffic for an extended period of time, which can cause people to become agitated and reckless, and potentially get into accidents that will further delay the evacuation.

Moreso, even after the gridlock condition is cleared and traffic begins moving, there are residual effects of the gridlock condition from the accordion effect. The accordion effect is seen in traffic when vehicles accelerate and decelerate in response to the vehicles in front of them. When the speed fluctuations in the flow of traffic change abruptly, like vehicles slowing abruptly when approaching the gridlock, the vehicles behind also slow down, which creates a chain reaction of breaking that compresses the cars together in traffic and removes gaps between cars traveling. When the gridlock condition clears, the cars in the front of the line of traffic begin accelerating and spreading out, similar to an accordion. This situation of cars spreading out when allowed to accelerate forward and compressing when having to slow down propagates outward from the initiating event and can affect drivers miles away. Resultingly, the accordion effect causes residual traffic back-ups that are not immediately resolved when the gridlock condition clears.

A multitude of other problems are created with the high volume of atypical vehicular traffic during evacuations. For instance, as mentioned above, control infrastructure (for example traffic lights) are poorly set up to handle these atypical traffic flows. Even traffic light systems with in ground detectors and the like are not designed to function with traffic that is completely, or almost completely, travelling in a common direction. Because of this, traffic signals are often overridden by the presence of police officers who direct traffic to move in a manner inconsistent with the instructions of the traffic signals. However, this requires multiple resources, including police personnel and other public safety personnel and resources, to be used for traffic control as opposed to doing other tasks, such as going door-to-door to ensure evacuation compliance or dealing with other public safety concerns that can arise in an evacuation.

If systems aren't overridden by the presence of traffic officers, as described above, individuals may become irritated with the ill-working traffic systems that are not designed for evacuations and will likely start to ignore the systems because of their concerns about being in an evacuation, and what they see as potentially illogical action of the traffic systems. All of this can also cause evacuating individuals to potentially panic, which can create further traffic problems. For example, a panicking driver could get stuck in a location where they are blocking other traffic or may cause an accident that results in massive traffic backups and delays.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, there is a need to provide for traffic controls systems, and methods of their operation, that are designed to provide for unique traffic control in the event of an evacuation by utilizing existing signal lights and a priority system which grants vehicles priority based on the needs of an evacuation traffic flow, as opposed to traditional traffic flows. These systems will typically be arranged to maximize traffic flow into and along a known evacuation route while still recognizing that vehicular traffic along other routes, and even opposing routes, particularly for emergency vehicles, is necessary.

There is described herein, among other things, a method for assisting a traveler to reach an evacuation route, the method comprising: providing a plurality of travelers, said plurality of travelers traveling toward an evacuation route via a plurality of different paths each of said paths meeting at least one other path at an intersection, each of said travelers having a location and direction of travel; evaluating said location and direction of travel of said travelers to determine a selected path in said plurality of paths which would get said traveler to said evacuation route; assigning a priority to said traveler for said traveler go through said intersection based at least in part on said selected path; and altering a traffic signal at said intersection based on said assigned priority.

In an embodiment of the method, the assigning includes determining which path in said plurality of different paths has the most travelers thereon.

In an embodiment of the method, the assigning includes determining which path in said plurality of different paths is a most direct path to said route.

In an embodiment of the method, the assigning includes determining which path in said plurality of different paths takes a shortest distance to get to said route.

In an embodiment of the method, the assigning includes determining a type of vehicle said traveler is utilizing.

In an embodiment of the method, the vehicle is an autonomous vehicle.

In an embodiment of the method, the vehicle is a mass transit vehicle.

In an embodiment of the method, the vehicle is an emergency vehicle.

In an embodiment of the method, multiple travelers are in a common vehicle on said path and said assigning includes determining a number of travelers in said common vehicle.

In an embodiment of the method, the evacuation route is a predetermined route selected based on a type of evacuation being performed.

In an embodiment of the method, the type of evacuation relates to a wildfire.

In an embodiment of the method, the type of evacuation relates to a flood.

In an embodiment of the method, the type of evacuation relates to a tsunami.

In an embodiment of the method, the type of evacuation relates to a hurricane.

In an embodiment of the method, the traffic signal is altered in a manner inconsistent with any normal traffic flow through said intersection.

In an embodiment of the method, the traveler is using a mobile device and said mobile device provides said location and direction of travel.

In an embodiment, the method further comprises: communicating to said mobile device instructions related to said traveler about said path.

In an embodiment of the method, the instructions indicate how said traveler should react to said traffic signal.

### BRIEF DESCRIPTION OF THE DRAWINGS

FIG. 1 provides an example of a portion of a traffic grid utilizing the disclosed systems and methods for traffic control during an evacuation.

### DETAILED DESCRIPTION OF PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives, and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Generally, the systems and methods for the detection of and communication with individuals at roadway intersections described herein is contemplated for use in an applicable traffic control system known to those of ordinary skill in the art and, in certain embodiments, is integrated into existing systems known to those of ordinary skill in the art that monitor and control the operation of traffic signals. In an embodiment, the systems and methods discussed herein are used in conjunction with various traffic control priority systems where certain vehicles may be given priority over others at a particular time as opposed to systems that utilize timing algorithms to determine traffic flow.

In certain embodiments, the systems and methods discussed herein are designed to work for any individual by detecting the presence of the individual at the intersection. This includes the individual being a pedestrian, a driver, and/or passenger in any type of vehicle, particularly those not easily detected by traditional methods, that could benefit from the system described herein.

This disclosure therefore provides a system that focuses on the individual “traveler” (where a traveler is effectively an individual person or a unit based on a person, for example, a self-driving vehicle with no human on-board) as opposed to an individual vehicle as the determining factor of how to select priority for any traveler in the system. For example, it is contemplated that the system could be applied to and utilized by people aboard motorcycles, scooters, personal mobility devices, golf cars or golf carts, smart vehicles, or other vehicles not easily or reliably detected by traditional detection methods used to detect motor vehicles. It could also be used by those in more traditional motor vehicles (including autonomous vehicles) such as cars and trucks where the system may detect a passenger instead of or in addition to the vehicle itself.

The system may also be used to detect pedestrians, such as those who may be walking, running, skateboarding, roller blading, or otherwise utilizing a street or sidewalk for travel, recognizing that these individuals may be moving at very disparate speeds from each other. In this disclosure, all the above individuals will be referred to as “travelers”. The key trait of a traveler is simply that a traveler is an individual being evacuated, that the traveler has at least one intersection between them and the desired end point (i.e., the point of safety), and that the traveler needs to interact with or go through that at least one intersection during the evacuation process.

Throughout this disclosure, the term “computer” describes hardware that generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including, but not limited to eyewear, wrist wear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, may refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices that are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

For purposes of this disclosure, there will also be significant discussion of a special type of computer referred to as a “mobile communication device”. A mobile communication device may be, but is not limited to, a smart phone, tablet PC, e-reader, satellite navigation system (“SatNav”), fitness device (e.g., a Fitbit™ or Jawbone™) or any other type of mobile computer whether of general or specific purpose functionality. Generally speaking, a mobile communication device is network-enabled and communicating with a server system providing services over a telecommunication or other infrastructure network. A mobile communication device is essentially a mobile computer, but one which is commonly not associated with any particular location, is also commonly carried on a traveler's person, and usually is in constant communication with a network.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software may be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the term “network” generally refers to a voice, data, or other telecommunications or similar network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network. Servers and clients may also exist virtually in so-called “cloud” arrangements.

Throughout this disclosure, the term “real-time” generally refers to software performance and/or response time within operational deadlines that are effectively generally cotemporaneous with a reference event in the ordinary user perception of the passage of time for a particular operational context. Those of ordinary skill in the art understand that “real-time” does not necessarily mean a system performs or responds immediately or instantaneously. For example, those having ordinary skill in the art understand that, where the operational context is a graphical user interface, “real-time” normally implies a response time of about one second of actual time for at least some manner of response from the system, with milliseconds or microseconds being preferable. However, those having ordinary skill in the art also understand that, under other operational contexts, a system operating in “real-time” may exhibit delays longer than one second, such as where network operations are involved which may include multiple devices and/or additional processing on a particular device or between devices, or multiple point-to-point round-trips for data exchange among devices.

Those of ordinary skill in the art will further understand the distinction between “real-time” performance by a computer system as compared to “real-time” performance by a human or plurality of humans. Performance of certain methods or functions in real-time may be impossible for a human, but possible for a computer. Even where a human or plurality of humans could eventually produce the same or similar output as a computerized system, the amount of time required would render the output worthless or irrelevant because the time required is longer than how long a consumer of the output would wait for the output, or because the number and/or complexity of the calculations, the commercial value of the output would be exceeded by the cost of producing it.

It needs to be recognized that for the purposes of this disclosure certain assumptions will be made about the nature of an evacuation as contemplated herein. The first is that the evacuation will typically be for a defined geographic location. That is, the systems and methods are directed to evacuating a town, city, complex, or similar geographically situated location as opposed to evacuating a mass transit vehicle (such as an aircraft) or a single building (such as an office tower). The next of these is that a majority of the evacuated persons will be utilizing standard passenger motor vehicles such as cars, light trucks, and motorcycles to evacuate the location area. The next is that a local government, or other authority, has previously developed an evacuation route which is to be used in this particular evacuation. The route may be one of multiple routes that have been developed to provide for a variety of different evacuations based on the direction the evacuation needs to occur or the type of evacuation. For example, the route may be one to evacuate the area to be evacuated towards the west. That same area may also have routes determined for evacuation of the same area towards the east, south, or north, in multiple, or in all of these directions at once in the event of different concerns. Typically, the local government, emergency response personnel, and/or the emergency organization or other government entity initiating the evacuation will select the pre-prepared route to be used during the evacuation.

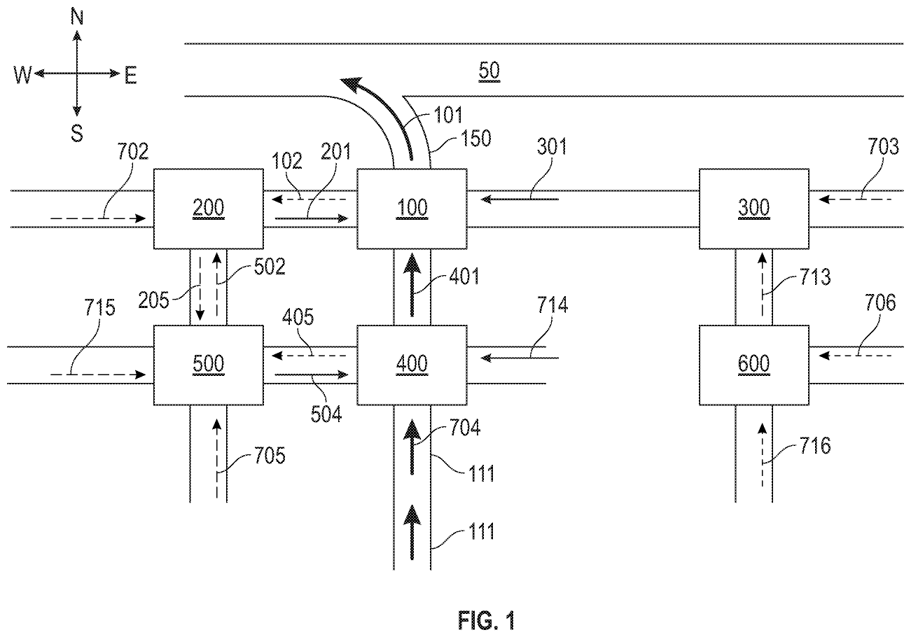

For the purposes of this disclosure the particular route of evacuation is not relevant, only that there is a pre-prepared route which has been previously determined and is selected for this particular evacuation and that this route is supposed to be used by evacuees. In this disclosure, this selected pathway is called simply the “route”. With reference to FIG. 1, the route (111) comprises the pathway indicated by the thick arrows (704), (401) and (101). This route (111) serves to channel vehicles through various intersections, such as (100) or (400), and to feed vehicles onto an interstate (50) via an on-ramp (150). Once a vehicle has reached the interstate (50), it is effectively no longer subject to existing traffic regulation infrastructure which would be altered due to the evacuation. Thus, this vehicle can be considered to have been successfully evacuated when the vehicle reaches the interstate although it should be recognized that someone on the interstate would likely continue to evacuate the area.

The route (111) may have different levels of granularity depending on the location, the preparation of the designing entity, and the nature of the cataclysm which is being evacuated from. Further, the nature of the road comprising the route (111) is not fixed. Typically the route (111) will include at least one major thoroughfare for leaving the evacuated area to which individuals within the area are to go in order to further leave. This major thoroughfare will typically include traffic control signals for vehicles which are on this major throughfare as is the case with the route (111) going through intersections (100) and (400) in FIG. 1. However, it will not be uncommon for the route (111) to be comprised of multiple thoroughfares that eventually merge into a single thoroughfare for leaving the evacuated area.

The important element of the route (111) is that once a vehicle being evacuated is on the route (111), there is typically no need to get off of it to get on any other road. However, some vehicles may still get off the route (111) for a variety of reasons, such as to refuel the vehicle or for a restroom break for the passengers in the vehicle, regardless of the severity and speed of the evacuation. Further, when the emergency evacuation systems and methods of the present disclosure are activated, traffic flow on the route (111) will be primarily, but not exclusively, in a single direction, which is the direction of the evacuation.

It should be recognized that while the route (111) may and typically will include traffic control signal infrastructure along it (intersections (100) and (400)), getting onto the route (111) will also involve going through other intersections (e.g. intersections (200), (300), (500) and (600) in FIG. 1) for most vehicles. Said differently, some vehicles will begin their evacuation at a roadway that either is part of the route (111) or directly feeds into the route (111). Conversely, other vehicles will begin their evacuation on a roadway separate from the route (111) and will have to navigate to the route (111) via one or more intersections, such as (200), (300), (500), (600), or others not depicted. Particularly, in more urban areas, it will be common that most individuals evacuating the area will be required to navigate through at least one intersection (200), (300), (500), and/or (600) to get to the route (111).

Getting to the route (111) from any intersection (100), (200), (300), (400), (500) and (600) will typically always involve the same basic decision issue. In virtually every intersection, there will be roads coming into the intersection with vehicles on those roads attempting to get on the route (111). The disclosed systems and methods work to direct the vehicles on those roads through the intersection, onto a path that gets them closer to getting on the route (111), and eventually getting those vehicles on the route (111). To accomplish this, the disclosed systems and methods can prioritize vehicles on different paths based on whether the path is the route (111), a path directly leading to the route (111), a path indirectly leading to the route (111), or a path leading away from the route (111). Specifically, the path being taken by a particular vehicle can serve to provide a level of priority to the vehicle for going through an intersection to enhance the speed that vehicles both get to the route (111), and use the route (111).

In FIG. 1, this priority of paths is illustrated by the weight of the arrows of travel. Specifically, traffic which is moving along the heaviest arrows (101), (401), and (704) are on the route (111). Traffic which is moving along the thinner but solid arrows (201), (301), (504), and (714) are not on the route (111) but are on a path which leads directly to an intersection (100) or (400) which allows them to get on the route (111).

Traffic which is moving along the long dashed arrows (702), (502), (715), (705), (713), and (703) are on a path approaching an intersection (300), (200), or (500) from which they can be directed onto a path (201), (301), or (504) which leads to an intersection (100) or (400) and ultimately allows them to get on the route (111). This is effectively one intersection further from the solid arrow paths. There are also the short dashed arrow paths (102), (405), (706) and (716) which are on a path still one more intersection further removed from the route (111). Traffic which is closer to the route (111) may have priority over traffic further from the route (111) or traffic on a particular path to get to the route (111) (which path involves travelling along increasingly solid arrows) may have priority over a different path covering different arrows, but with similar increasing solidity.

It should be recognized that if FIG. 1 was expanded to provide a full traffic grid, this pattern of paths could be extended indefinitely and would eventually cover any path a vehicle could take on any road giving it a level of priority. In order to completely understand FIG. 1, it should also be recognized there are paths which are not shown with any arrow. For example, the path of traveling south from intersection (100) to intersection (400), which is the path opposite the arrow (401). In FIG. 1, these are paths which lead away from or go the wrong direction to get to the route (111) (or in the case of the example above go the wrong way on the route (111)). For the purposes of FIG. 1, these paths are not impossible to take, they are simply categorized lower priority than the present disclosure can fully depict, as drawing out and labeling the entire traffic system would overly complicate this disclosure. However, it should be clear that the paths (102), and (405) also travel away from the route (111). These have been provided to illustrate how every path can be given a level of priority into and out of every intersection. Thus, discussion of them will allow for extrapolation of the logical pattern continuing down the priority chain.

In an evacuation, the systems and methods disclosed herein will utilize an existing priority system at the various intersections to provide for priority in getting vehicles to a path which gets them closer to the route (111), getting those on various paths on the route (111), and eventually to the interstate (50) which is effectively the goal of this exemplary evacuation plan. The priority system may use a personal mobile communication device specific to an individual to detect the presence of and determine priority of vehicles. The techniques used by the priority system determining priority are described in various prior patents and patent applications, including U.S. Pat. Nos. 11,202,302, 11,250,700, and U.S. patent application Ser. No. 18/233,151, the entire disclosures of which are herein incorporated by reference. Other techniques may also be used for determining priority of vehicles through intersections.

For purposes of this disclosure, it should be recognized that the emergency evacuation system does not base priority solely on the number of vehicles on any given path or at any given intersection, nor is priority based solely on the output of an existing priority system utilized. Rather, upon activation of the emergency evacuation system, the priority of the vehicles on any given path may be based on a combination of information collected from the priority system used and information about the pre-determined evacuation route. For example, priority may be based on where the path is in a predefined area, the direction of travel on that path, the number of passengers in the vehicle, the number of evacuees on that path, and any combination thereof. Additional factors in determining priority may be available in some embodiments such as the type of vehicle being used (e.g. an emergency or mass transit vehicles as opposed to a personal car).

When the evacuation system of the present disclosure is activated, which will typically be during an emergency situation, the traffic lights on the route (111) will typically be staggered such that all traffic lights on the route (111) are not green or red at the same time. As an exemplary example of this, the traffic light at intersection (100) may be green on the route (111) with the traffic light at intersection (400) red on the route (111). While the traffic light at intersection (400) is red on the route (111), it will be green on the cross streets, i.e., traffic approaching intersection (400) on path (504) and (704) will have a green light to permit traffic on those paths to enter the route (111).

Likewise, traffic lights on the paths leading to the route (111) will also be staggered in a similar manner. Thus, when traffic is flowing on path (715) through intersection (500) and onto path (504), the traffic light at intersection (500) may be green while the traffic light at intersection (400) may be red. This staggering of the traffic lights helps to maintain a continuous flow of traffic towards the route (111) on all paths leading to the route and helps to avoid the creation of gridlock conditions that would otherwise be common during an evacuation. However, this description of the staggering traffic lights is merely intended to provide a high-level example and the actual traffic light operation, particularly the staggering of the lights, that occurs when the disclosed systems and methods are activated is not necessarily strictly as systematic as this example.

When the emergency evacuation system of the present disclosure is activated, the traffic lights will stagger their signals based, in part or in whole, on the particular priority system used. For example, if the priority system is one that provides priority based on the number of vehicles on a path, the path with the most vehicles will have green traffic lights, while the path with less vehicles will have red traffic lights. These priority systems, while possible to be used with the evacuation system of the present disclosure, could violate traffic convention by having three red lights and one green light at an intersection, and are less preferred embodiments.

The preferred priority system to be utilized in conjunction with the disclosed emergency evacuation systems and methods is a priority system that assists users through an intersection via a mobile device, such as described in U.S. Pat. No. 11,202,302. This is because most, if not all, individuals travelling have some mobile communication device with them. The disclosed systems and methods utilizing this type of priority system thus may use information from the priority system, such as how many devices are detected on a path, to determine how many evacuees are on a particular path. Based on the number of evacuees on a particular path, the system may then determine which path to assign priority and direct the evacuees on that path towards or onto the route (111), as described further herein.

While these priority systems have been known in the art for general traffic priority since about 2019, the use of these systems during an evacuation is not known in the art. Specifically, the prior uses of these priority systems centered around clearing paths for emergency vehicles, mass transit vehicles, or other specific individuals based on their need for priority. These systems were not contemplated to be used during an emergency evacuation where nearly all traffic is flowing in the same direction and where nearly all, or all, of a population in a given area is attempting to evacuate the area in an orderly manner. The disclosed systems and methods use these priority systems in a much different manner than how previously used or previously contemplated.

For example, while the existing priority systems may have determined priority based on the number of travelers on a path, they did not consider or account for all travelers travelling towards a central endpoint (i.e., the evacuation route), and specifically intended to keep traffic flowing throughout a traffic grid, generally. Comparatively, the emergency evacuation system of the present disclosure may use these priority systems to provide priority based on the number of evacuees traveling to the evacuation route (based on information from the priority system on the number of mobile devices on a path, for instance), and then may determine which path leading to the route (111) has the most evacuees. Using this information, the system may stagger the traffic lights at the intersections (100), (200), (300), (400), (500), and (600), to permit the most amount of evacuees to enter the route (111).

It should be noted that, due to the nature of an evacuation, the paths with the highest numbers of evacuees will inevitably be the paths on the route (111) and those directly adjacent to the route (111). As shown in the depicted example in FIG. 1, these will be paths (401), (704), (201), (301), (504), and (714). Because of this, simply staggering traffic lights to permit the paths with the most amount of evacuees may not be effective, as the paths closest to the route (111) will almost always have priority and the paths one or more intersections away from the route (111) will rarely have priority. This could create a gridlock condition where the traffic lights at intersections closest to or on the route (111) are green, but no traffic is able to move forward due to the volume of vehicles on the route (111) attempting to enter the interstate (50). To account for this, the disclosed evacuation system may consider the volume and movement of the vehicles on the route (111) and may intentionally turn a traffic light leading to the route (111) red to restrict access to the route (111) and allow the existing traffic on the route (111) time to clear. When traffic on the route (111) has sufficiently cleared enough to allow vehicles to begin moving again, the system may then begin to allow additional vehicles access to the route (111).

In addition, the disclosed system may also account for the volume of vehicles on paths upstream or downstream of the route (111) and the particular path's proximity to the route (111) when assigning priority, which may permit a continuous, or near continuous, flow of traffic entering the route (111), while still allowing traffic on the route (111) to flow towards the interstate (50) and avoid gridlock condition. To accomplish this, the evacuation system may consider the priority indicated from the priority system for the paths closest to the route (111), that is, paths (201), (301), (504), (714), etc., and the priority indicated for the paths further away from the route (111), that is, paths (702), (715), (703), (706), (713), (716), etc. The system than may stagger traffic lights at the intersections to clear a path for the traffic further away from the route (111) while still moving traffic closest to and on the route (111).

To illustrate this, consider the depicted example of FIG. 1 and consider the priority system having identified path (702) as the path with the most evacuees, thus the path with priority. The traffic lights at intersections (200) and (100) may stagger to allow the traffic on path (702) to have clear access to the route (111) via intersection (200) and path (201), with the light at intersection (200) turning green for traffic flowing to the east and west and red for traffic flowing to the north. While traffic on path (702) is moving toward intersection (100), the traffic lights at intersection (100) and (400) may be green for northbound traffic and red for traffic flowing east and west. When the traffic on path (702) moves forward to reach intersection (100), the disclosed evacuation system may turn the traffic light at intersection (100) green for traffic flowing to the east and turning onto on-ramp (150), and may turn the light red for traffic flowing to the west and north. Staggering the lights like this may permit traffic on the route (111) to continue moving toward the interstate (50), while also allowing traffic on other paths to continue moving toward the route (111).

While traffic on path (702) is working its way to the route (111), the system may simultaneously identify path (714) as having a high number of evacuees. The system may then begin to direct traffic on path (714) onto the route (111) by turning the traffic light at intersection (400) green for the westbound traffic entering the route (111), while maintaining the light at intersection (100) red for the northbound traffic on the route (111) until the number of evacuees on path (401) exceeds the number of evacuees on path (201). This allows traffic from paths (702) and (201) to enter the route (111) and access the on-ramp (150) while also permitting traffic on path (714) to enter the route (111). When the number of evacuees on path (401) exceeds the number of evacuees on path (201), the system may then shift the traffic lights at intersection (100) to be green for northbound traffic and red for eastbound and westbound traffic.

While the system is shifting the traffic lights at intersections (100) and (400) to maintain traffic flowing towards to interstate (50), the system may also continue to detect the number of evacuees on paths directly adjacent and one or more intersections away from the route (111). When traffic clears on path (702) to a point where the system detects another path as having the most amount of evacuees, the system may begin to shift the traffic lights again to direct traffic on the new most populated path to the route (111).

If path (705) is the next path identified as having the highest number of evacuees, the light at intersection (500) may turn green for northbound traffic, permitting traffic to either go straight to intersection (200), which may also be green for northbound traffic, or turn right onto path (504). While traffic is moving toward the route (111), traffic lights for northbound traffic at intersections (100) and (400) may be green to permit the traffic on the route to enter the on-ramp (150). When traffic from path (705) reaches intersection (400), the light at intersection (400) may turn red for northbound traffic and green for eastbound traffic entering the route (111).

Like before, while the evacuation system is moving traffic from path (705) to the route (111), the system may identify another path as having a high number of evacuees and configure the traffic lights on that path to permit that traffic to flow towards the route (111) without impeding moving traffic from path (705) onto the route (111). This configuration of the evacuation system continuously identifying paths with high numbers of evacuees and shifting traffic lights to permit the most number of evacuees access to the route without impeding other evacuating paths, allows for a near continuous flow of traffic onto the route (111) and onto the on-ramp (150).

It should be noted that these examples have been provided to illustrate how the disclosed system may utilize priority systems to facilitate the evacuation by staggering traffic lights based on the number of evacuees on any given path. The process described in these examples may repeat itself throughout the area being evacuated until the evacuation process is terminated, which may ensure all evacuees are promptly and safely evacuated as quickly as possible.

In addition to the disclosed systems and methods using these priority to efficiently direct traffic through paths to eventually end up on the route (111), the disclosed system may also direct distant evacuees, that is, those evacuees at intersections further away from the route (111) than what is illustratively depicted in FIG. 1, to the route (111) in a similar manner, but adding additional steps. The distant evacuees may be routed through areas with ample businesses in pass-through communities to provide access to fuel, food, and toilets for the persons evacuating. This is because, as mentioned above, when a vehicle enters the route (111), it is desirable for that vehicle to have no need to exit the route (111). By intentionally routing the evacuees through areas with such ample resources, the system provides multiple opportunities for the evacuees to take refueling breaks, or other breaks, as necessary prior to reaching the route (111). This may serve to reduce the number of vehicles that need to exit the route (111) when they eventually get to the route (111).

Furthermore, because an emergency evacuation can be initiated by a number of situations, and many times those situations are not static and change over time, the disclosed emergency evacuation system may be configured to alter the path of evacuation based on such changing circumstances. If a situation arises that requires altering the evacuation route, such as if the initiating event is a wildfire that has abruptly changed paths, the emergency response personnel and organization that initiated or is in control of the evacuation may select a new pre-prepared evacuation route. In such a circumstance, if the existing route (111) is not in imminent danger, the disclosed evacuation system may continue to direct the vehicles currently on the route (111) and on the paths immediately adjacent to the route, i.e., paths (201), (301), (504), (714), to the interstate (50), and begin to direct the traffic on paths further away from the original route (111) to the newly designated evacuation route.

Directing the vehicles to the newly designated evacuation route may be accomplished in a manner similar to how the disclosed system directed vehicles onto the route (111). For example, if the new evacuation route is east of intersections (200) and (500), the system may turn the traffic light at intersection (300) red for all northbound traffic turning left, red for westbound traffic going straight, and green for northbound traffic turning right and green for westbound traffic turning left. Continuing on, the system may turn the traffic light at intersection (600) green for southbound traffic, and red for northbound traffic going straight. While traffic on the prior evacuation route (111) is being cleared to the interstate (50), the system may direct the traffic around intersections (300) and (600) around intersections (100) and (400), which may allow the traffic on the prior route (111) and the traffic on the paths directly adjacent to the prior route (111) to make its way onto the interstate (50), while not adding more traffic to these paths. When the traffic on the prior route (111) is sufficiently cleared, the system may then begin to direct traffic through intersection (100) towards the new evacuation route by turning the traffic light at intersection (100) green for traffic turning east and red for traffic flowing northbound. Similarly, the system may begin to utilize intersection (400) to direct traffic to the new evacuation route after traffic on the prior route (111) has sufficiently cleared. The system may continue this pattern until all the traffic in that area is directed away from the previous route (111) and towards the new evacuation route.

If the existing route (111) is in imminent danger, the disclosed evacuation system may completely restrict access to the route (111) and direct traffic that was on the route (111) away from the danger. The system may further restrict access to paths (201), (301), (504), (714), which are immediately adjacent to the route, by turning the respective traffic lights that lead to those paths red and directing traffic that was on those paths to alternative paths that are away from the danger. In this situation, the system may identify which paths have the most and least amount of evacuees and direct the traffic on the paths with the most amount of evacuees to the paths with the least amount, and simultaneously direct the traffic on the paths with the least amount of evacuees to the new evacuation route. When the first path directed away from the route (111) has less evacuees than a second path, the system may shift the traffic lights to direct evacuees on the second path away from the route (111). When the second path has less evacuees than a third path, the system may again shift and direct the evacuees on the third path away from the route (111). Again, this process may continue until all evacuees have been directed away from the route (111) and towards the new evacuation route.

Additionally, when the emergency evacuation system of the present disclosure is triggered, the system may work in concert with existing emergency notification systems that provide updates via a mobile communication device. The integration of the existing notification system with the disclosed evacuation system may provide evacuees updates and notices regarding the evacuation route, the start time of the evacuation for the user receiving the alert, the status of paths leading to the evacuation route, the status of traffic conditions on the evacuation route, updates if the evacuation route is changed from the initial route, and may provide an estimated time for the user to reach the point of being considered evacuated.

The estimated time of the user reaching the point of being considered evacuated may be determined by a system and method similar to, but not identical to, the system and method as described in U.S. Pat. No. 8,878,695, Signal Light Priority System Utilizing Estimated Time of Arrival, the entire disclosure of which is hereby incorporated by reference. Rather than using a vehicle computer unit (VCU) to determine the location of the vehicle, as disclosed in U.S. Pat. No. 8,878,695, the disclosed evacuation system may use a Global Positioning System (GPS), or similar technology, that is included in a user's mobile communication device.

By using a GPS in a mobile communication device, the evacuation system of the present disclosure may be able to track, real-time, where the evacuees are located. The system may then use that information, in conjunction with the path the system has determined the evacuees may be directed on, to determine the estimated time of arrival at the point of being considered evacuated. The system may further provide real-time updates of the estimated arrival time, by means of sending a notification to the evacuee's mobile device, as conditions change or in the event the evacuee veers off the path determined by the system.

The system may also provide instructions about how to access the route, and both that the evacuee should follow the traffic signals and how they should follow the traffic signals. For example, in the event that the evacuee's location can be identified from that mobile device, the mobile device may then provide instructions to the evacuee on how to follow the route most effectively. As a simple example, the evacuee may receive a message indicating that since they are currently heading west on main street, when the light at the central street intersection turns to a green left arrow, they should proceed to turn left to join the evacuation route. The instruction can even allow the user to disobey certain traffic rules. For example, it may instruct all evacuees on main street to turn left, regardless of which lane they are currently in. Similarly, the instruction may also discourage certain behavior by explaining what the lights will do. For example, the instruction may indicate that no green orb (straight) will appear for cars on main street going west as they should not proceed through the intersection straight or turn right. All cars should turn left.

The system may further provide information about the estimated times of arrival for the evacuees to local emergency response authorities and other designated personnel. The personnel may use this information to determine whether to alter the evacuation route or whether additional (or fewer) emergency response personnel in a particular area based on how many evacuees remain in that area. For example, if the disclosed evacuation system provides information to emergency response personnel that a large number of evacuees are estimated to arrive at the point of being considered evacuated after the event the evacuees are being evacuated from, the emergency personnel may choose to alter the path of evacuation to ensure the most amount of evacuees possible are adequately evacuated to safety.

Alternatively, the evacuation system of the present disclosure may use the information about estimated times of arrival to automatically begin directing evacuees to a different path of evacuation when the number of evacuees determined to arrive at the point of being considered evacuated reaches a predetermined threshold level. In such a case, the system may function as described above in the situation of a change in evacuation route, or may divert evacuees to different paths that lead to the route (111), if an alternative path is available and would provide the evacuees a faster arrival time.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “spherical” are purely geometric constructs and no real-world component or relationship is truly “spherical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A method for assisting a traveler to reach an evacuation route, the method comprising:
providing a plurality of travelers, said plurality of travelers traveling toward an evacuation route via a plurality of different paths each of said paths meeting at least one other path at an intersection, each of said travelers having a location and direction of travel;
evaluating said location and direction of travel of said travelers to determine a selected path in said plurality of paths which would get said traveler to said evacuation route;
assigning a priority to said traveler for said traveler go through said intersection based at least in part on said selected path; and
altering a traffic signal at said intersection based on said assigned priority.

2. The method of claim 1, wherein said assigning includes determining which path in said plurality of different paths has the most travelers thereon.

3. The method of claim 1, wherein said assigning includes determining which path in said plurality of different paths is a most direct path to said route.

4. The method of claim 1, wherein said assigning includes determining which path in said plurality of different paths takes a shortest distance to get to said route.

5. The method of claim 1, wherein said assigning includes determining a type of vehicle said traveler is utilizing.

6. The method of claim 5, wherein said vehicle is an autonomous vehicle.

7. The method of claim 5, wherein said vehicle is a mass transit vehicle.

8. The method of claim 5, wherein said vehicle is an emergency vehicle.

9. The method of claim 1, wherein multiple travelers are in a common vehicle on said path and said assigning includes determining a number of travelers in said common vehicle.

10. The method of claim 1, wherein said evacuation route is a predetermined route selected based on a type of evacuation being performed.

11. The method of claim 10, wherein said type of evacuation relates to a wildfire.

12. The method of claim 10, wherein said type of evacuation relates to a flood.

13. The method of claim 10, wherein said type of evacuation relates to a tsunami.

14. The method of claim 10, wherein said type of evacuation relates to a hurricane.

15. The method of claim 1, wherein said traffic signal is altered in a manner inconsistent with any normal traffic flow through said intersection.

16. The method of claim 1, wherein said traveler is using a mobile device and said mobile device provides said location and direction of travel.

17. The method of claim 16, further comprising:
communicating to said mobile device instructions related to said traveler about said path.

18. The method of claim 17, wherein said instructions indicate how said traveler should react to said traffic signal.
